(19) United States
(12) Patent Application Publication
(10) Pub. No.: US 2020/0107566 A1
(43) Pub. Date: Apr. 9, 2020

(54) CRUCIFEROUS VEGETABLE FORMULA AND METHODS OF PREPARATION FOR USE IN FOODS AND BEVERAGES

(71) Applicants: David Ian Forbes, Falls Church, VA (US); Kristan Leigh Anderson, Falls Church, VA (US); Sharon Flank, Washington, DC (US); David D Austin, II, Falls Church, VA (US)

(72) Inventors: David Ian Forbes, Falls Church, VA (US); Kristan Leigh Anderson, Falls Church, VA (US); Sharon Flank, Washington, DC (US); David D Austin, II, Falls Church, VA (US)

(73) Assignee: Snack Kraken LLC, FALLS CHURCH, VA (US)

(21) Appl. No.: 16/154,157

(22) Filed: Oct. 8, 2018

(51) Int. Cl. A23L 19/00; A23L 27/60; A23L 2/54; A23L 2/02; A23L 2/46; A23L 23/00

(52) U.S. Cl. CPC A23L 19/09; A23L 27/60; A23L 2/54; A23V 2002/00; A23L 2/46; A23L 23/00; A23L 2/02

(57) ABSTRACT

A savory, healthy cruciferous vegetable formula includes cruciferous vegetable, aromatic, edible fruit ingredient, acid ingredient and seasoning. In one embodiment the formula is a pourable, dense, finely grained cruciferous vegetable condiment. In another embodiment, the formula is a carbonated cruciferous vegetable beverage. In one method a cruciferous vegetable condiment is produced by preparing, cooking and finely pureeing the nutrient-rich ingredients, then hot fill processing and packaging the shelf-stable condiment. In another method, a carbonated cruciferous vegetable beverage is produced by preparing, cooking, cooling and carbonating the nutrient-rich ingredients, then cold fill processing and packaging the shelf-stable beverage.

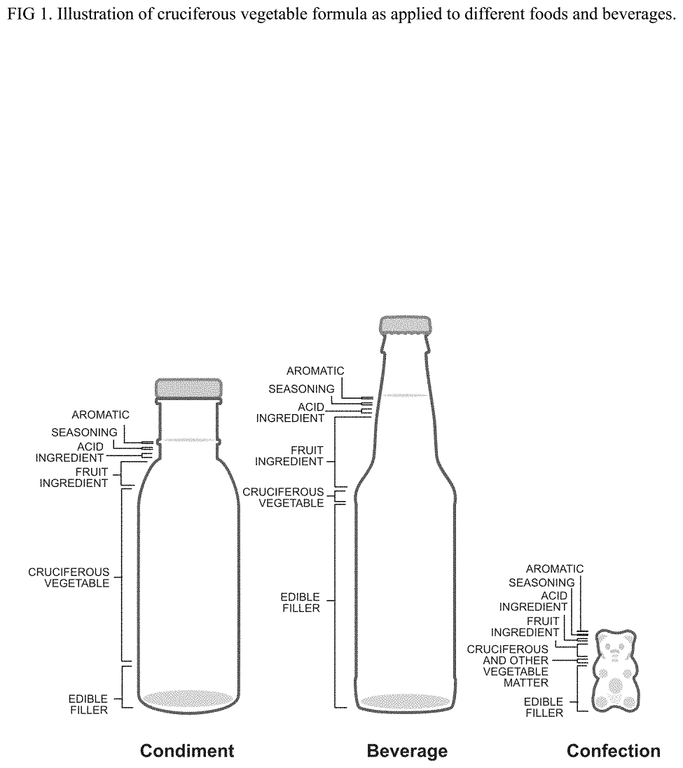

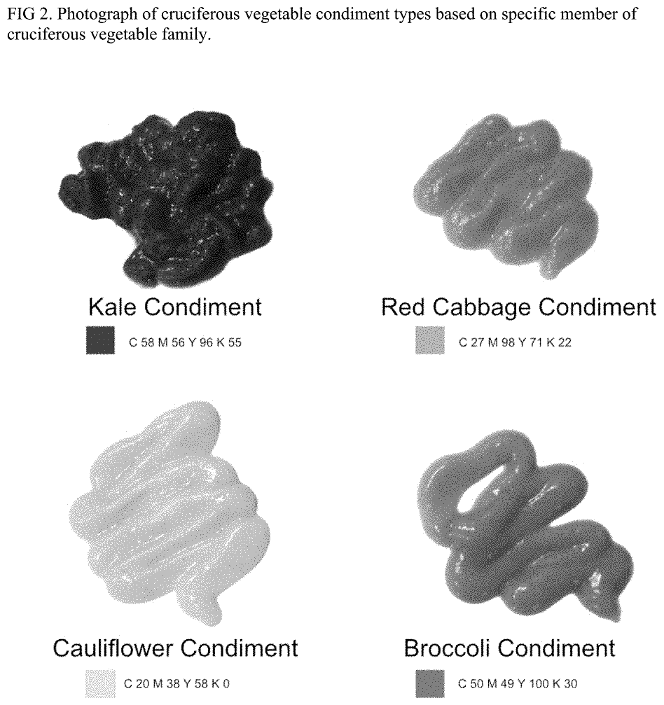

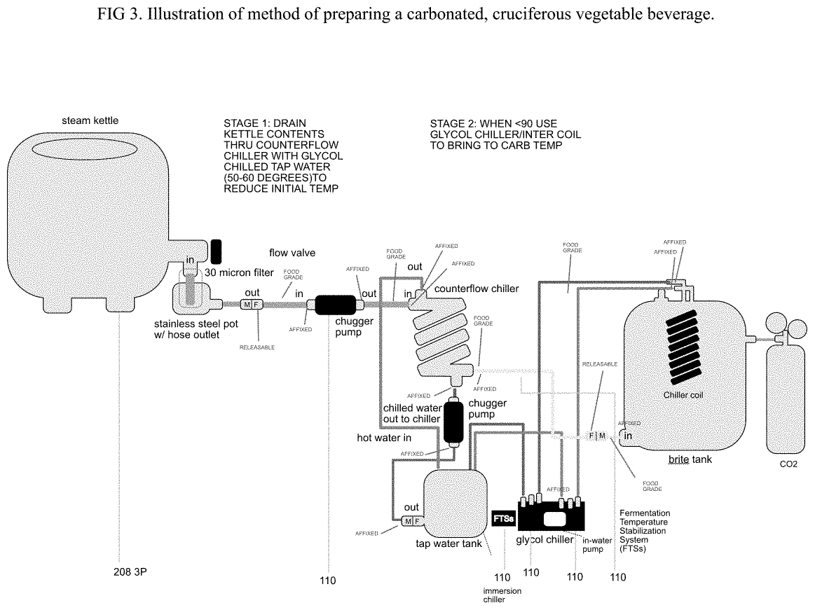

### BACKGROUND

### Field of the Invention

The present invention is a savory, healthy, cruciferous vegetable formula that, in one embodiment, is used to manufacture pourable, dense, finely grained cruciferous condiments. In another embodiment, the present invention is used to manufacture carbonated cruciferous beverages. The present invention is an all natural, low calorie, no added sugar, low sodium, low carbohydrate, cholesterol free, saturated fat free, high in vitamins and minerals, formula that is used to reimagine and then manufacture healthy and flavorful alternatives to traditionally unhealthy foods and beverages. FDA compliant health claims addressed by the present invention include “Dietary saturated fat and cholesterol and risk of coronary heart disease,” “Dietary fat and cancer” and “Sodium and hypertension.”

### Description of the Related Art

Traditional methods and recipes for manufacture of foods and beverages can be relatively unhealthy—high in fat, high in sugar, high in cholesterol, high in calories, high in sodium or all of the above.

Take condiments, for example—mayonnaise, the most popular condiment, is high in fat, calories, cholesterol and sodium. Even mayonnaise alternatives, which may be free of animal product, still use high-caloric vegetable fats as the base for the condiment.

Ketchup, while fat and cholesterol free, is typically high in calories, sugar and sodium. BBQ sauce is the same; salsa is lower in calories but traditionally high in sodium. Mustard, while low in calories, sugar and sodium, offers little nutritional benefit. Recent innovations in condiments are either hot sauces, which are small in serving and high in sodium or have been driven by the introduction and blending of condiments from other cultures, like sriracha mayonnaise. And beverages like soft drinks are exceptionally high in sugar, or use artificially sweeteners to replicate the sugar experience. Other food products that can benefit from the present invention include frozen and shelf stable confections, processed and packaged foods, baked goods and snack and convenience foods.

In the present invention, the majority ingredient in a given embodiment is of the cruciferous family of vegetables, which include kale, cauliflower, cabbage, collard greens, Brussels sprouts, broccoli, turnips, bok Choy, among others, all of which are considered nutritional powerhouses with myriad health benefits, and have been untapped in use as the primary component of a standardized formula to produce healthy alternatives and interpretations of traditional foods and beverages. For example, the formula can be used as a pourable, dense, finely textured condiment to augment and highlight the inherent flavor characteristics of carbohydrates, proteins and fats or as a low calorie savory soft drink that uses no added sugar or artificial sweeteners to provide a satisfying and thirst quenching experience.

The combination of this family of super foods with other traditional and nontraditional ingredients and methods of preparation makes the cruciferous vegetable formula novel and non-obvious. In one embodiment of the present invention, the pourable yet dense, finely textured, cooked cruciferous vegetable condiment, nothing similar exists today, in grocery stores or in recipe form for the home cook. For example, the cruciferous vegetable kale is prepared many different ways, from cooked sauces like creamed kale or sautéed kale with a splash of vinegar to cold, uncooked sauces like chimichurris, pestos and gremolatas—even as a wide variety of raw juices. Each of these dishes may have common ingredients with the kale condiment, but only this condiment combines these varied ingredients into a cooked, refined puree, which is processed, bottled and shelf stable, with the ability to augment and enhance other foods as a savory condiment.

In another embodiment, the carbonated cruciferous vegetable beverage is unique in that it uses a light vegetable broth as primary ingredient. Combined with the other ingredients it provides a refreshing, well-rounded mouth feel and flavor. A health benefit for this embodiment is that the up to 40% of vitamins and minerals that leach into cooking water are captured and retained in the beverage.

### SUMMARY

The present invention is a savory, healthy, cruciferous vegetable formula that is all natural, low calorie, no added sugar, low sodium, low carbohydrate, cholesterol free, saturated fat free and high in vitamins and minerals.

The present invention provides a delicate savory balance of sweet, salty, sour, spicy and aroma so that ingredients with negative health impact are eliminated or reduced to a minimum, yet a maximum amount of total flavor is delivered to the palate. A key innovation in the present invention is the use of aromatics to mask the pungent sulfur compounds released when cruciferous vegetables are heated, keeping the super food benefits while increasing overall palatability.

In one embodiment of the present invention a pourable yet dense, finely textured, cooked cruciferous vegetable condiment is produced consisting of cruciferous vegetable, other vegetables, edible fruit ingredient, aromatic, acidic ingredient and seasoning.

In another embodiment of the present invention a low calorie, carbonated cruciferous vegetable beverage is produced consisting of cruciferous vegetable, edible fruit ingredient, aromatic, acidic ingredient and seasoning.

In one embodiment the present invention is a method of preparation of pourable yet dense, finely textured, cruciferous vegetable condiment wherein ingredients are prepared, cooked, hot fill processed and stored unrefrigerated (shelf-stable) at pH of less than 4.5.

In another embodiment the present invention is a method of preparation of a low calorie, carbonated cruciferous vegetable beverage wherein vegetable ingredients are prepared and cooked then cooled, combined with other ingredients, carbonated then cold fill processed, then bottled and stored unrefrigerated (shelf-stable) at pH of less than 4.5.

### DETAILED DESCRIPTION

The cruciferous vegetable formula is not an old family recipe, nor is it the result of years of intensive research. The origin is entirely serendipitous and very recent.

In the early summer of 2017, the principal inventor was planning a barbeque to celebrate his son's high school graduation. As an amateur cook, the inventor often experiments with sauces and was noodling what kinds of sauces to serve. As he considered different types of green sauces, he surveyed his refrigerator inventory and noted a large bunch of kale. A thought popped into his head, “What about a kale-based, sauce with similar attributes (sweet, sour, salty, fine textured, dense, pourable) to a barbeque sauce or ketchup?” Turning to the Internet for a recipe, he searched and found . . . nothing. So he continued to search, tweaking and refining to tune the results. And still nothing useful, or even close. Then he looked for existing commercial products, and found nothing. Even when he expanded his search queries to other vegetables with similar attributes to kale, he found nothing that met his criteria.

Not one to give up on a notion no matter the outcome (meaning perhaps there was a very good reason no one has ever created a kale condiment), he took his beloved creamed kale recipe, added to it the key sweet, sour and salty components in a barbeque sauce or ketchup, tweaked a few things, and invented the kale condiment. Not only did it offer a fourth dimension of herbal savoriness, but required substantially less salt and sugar to achieve a balanced flavor.

The sauce was a hit at the graduation party, so the principal inventor continued to experiment with flavor, texture, viscosity (and learned a lot about chlorophyll, emulsification, liquefying and natural thickeners in the process), and consulted with knowledgeable associates who filled in his gaps in expertise (the co-inventors). Once convinced they had a viable and marketable formula, they then focused on refining the health aspects, experimenting with different cooking techniques for maximum retention of nutrients as well as the reduction of sodium and sugar content without sacrificing flavor.

Once it was determined that filing a patent had potential merit, during the due diligence process it was decided to broaden the scope of the patent to include the entire cruciferous family of vegetables. To validate this, the formula was standardized and extended to other cruciferous vegetables as well as tested in various forms of potential consumption such as dilution with liquid for drinking, reduction to syrup for flavoring and dehydration for flavoring powder.

The present invention is a savory, healthy cruciferous vegetable formula and methods of preparation used in foods and beverages. The invention is used to produce pourable yet dense, finely textured, cruciferous vegetable condiments and carbonated cruciferous beverages.

One embodiment of this invention is a method of preparation for a pourable yet dense, finely textured, cooked cruciferous vegetable condiment that includes, generally, cruciferous vegetable, other vegetables, aromatic, edible fruit ingredient, acid ingredient, liquid and seasoning.

In one embodiment of this invention the ingredients are prepared as follows: the vegetables are weighed, washed, drained, then coarsely chopped as needed. Washing after weighing makes the weight more accurate as there are no clinging water droplets that could skew the moisture content of the cooked vegetables, and washing before chopping helps minimize nutrient loss. The cruciferous vegetable is combined with other vegetables. aromatic, edible fruit ingredient, acid ingredient, liquid and seasoning, and cooked using moist heat and steam by being brought to a boil then simmered until tender. A multiple horsepower, high shear mixer is then used to grind the vegetables and nutrient-rich cooking liquid into a fine puree. Once the desired texture is achieved the product is brought up to the temperature specified by the product's approved process and then held at that temperature for the amount of time specified by the product's approved process.

In one embodiment of this invention water is also added to thin to the proper viscosity, as cruciferous vegetable water content can vary based on seasonality, growing variables and freshness.

In one embodiment of this invention the pH is tested and the time and pH results recorded. The hot fill temperature is also logged. Any deviations to the product's approved process are recorded and communicated to the author of the product's approved process, the process authority. Next, the condiment is bottled and packaged so that it is shelf-stable.

In one embodiment of this invention the cruciferous vegetable condiment provides a savory, flavorful and healthful alternative to currently available commercial condiments, and is equally flavorful and nutritionally beneficial when the vegetable used is any member of the cruciferous vegetable family.

### Example 1

A series of pourable yet dense, finely textured, cruciferous vegetable condiments were prepared.

In the first of these, the vegetable was kale, the seasoning was kosher salt and spices, the liquid was water, the other vegetables were garlic, onions and jalapeno peppers, the edible fruit ingredient was apple juice and lemon juice, the acid ingredient was cider vinegar and white vinegar, and the aromatic was lemon zest.

In the second of these, the vegetable was cauliflower, the seasoning was kosher salt and spices, the liquid was water, the other vegetables were garlic, onions and bell peppers, the edible fruit ingredient was fresh pear and lemon juice, the acid ingredient was rice vinegar and white vinegar, and the aromatic was lemon zest.

In the third of these, the vegetable was cabbage, the seasoning was kosher salt and spices, the liquid was water, the other vegetables were garlic, onions, beets and jalapeno peppers, the edible fruit ingredient was apple juice and lemon juice, the acid ingredient was cider vinegar and white vinegar, and the aromatic was lemon zest.

In the fourth of these, the vegetable was collard greens, the seasoning was kosher salt and spices, the liquid was water, the other vegetables were garlic, onions, and habanero peppers, the edible fruit ingredient was apple juice and lemon juice, the acid ingredient was cider vinegar and white vinegar, and the aromatic was lemon zest.

One embodiment of the present invention is a method of preparation for a carbonated, cruciferous vegetable beverage that includes, generally, cruciferous vegetable, aromatic, edible fruit ingredient, acid ingredient, liquid and seasoning.

In one embodiment of this invention the ingredients are prepared as follows: the cruciferous vegetable is weighed, washed, drained then coarsely chopped as needed. The cruciferous vegetable is combined with seasoning and liquid and cooked by being brought to a temperature and time lethal to bacteria.

In one embodiment of this invention the aromatic is fresh or dried and is cooked with the cruciferous vegetable to extract flavors.

In one embodiment of this invention the cooking solids are strained out while the cooking liquids are drained through a heat exchanger to rapidly reduce liquid temperature. The partially cooled cruciferous vegetable liquid is pumped into a refrigerated storage container and cooled down to less than 45° F.

In one embodiment of this invention the edible fruit ingredient and acid ingredient are added to the chilled cruciferous vegetable liquid and agitated to mix ingredients.

In one embodiment of this invention the aromatic is in liquid form, such as culinary grade essential oils or essences, and is added to the chilled cruciferous vegetable liquid along with the edible fruit ingredient and acid ingredient.

In one embodiment of this invention the chilled cruciferous vegetable liquid is carbonated using CO₂ to a PSI of 15.

In one embodiment of this invention the carbonated beverage is bottled using a cold fill process and packaged so that it is shelf-stable.

### Example 2

A series of carbonated, cruciferous vegetable beverages were prepared.

In the first of these, the cruciferous vegetable was cauliflower, the seasoning was sea salt, the liquid was water, the edible fruit ingredient was blood orange puree, the acid ingredient was cider vinegar and the aromatic was fennel culinary essential oil.

In the second of these, the cruciferous vegetable was cauliflower, the seasoning was sea salt, the liquid was water, the edible fruit ingredient was concentrated pineapple juice, the acid ingredient was cider vinegar and the aromatic was lemongrass culinary essential oil.

In the third of these, the cruciferous vegetable was cabbage, the seasoning was sea salt, the liquid was water, the edible fruit ingredient was concentrated cherry juice, the acid ingredient was cider vinegar and the aromatic was lime culinary essential oil.

In the fourth of these, the cruciferous vegetable was kale, the seasoning was sea salt, the liquid was water, the edible fruit ingredient was concentrated fig juice, the acid ingredient was cider vinegar and the aromatic was habanero peppers that were cooked with the kale as well as lemon culinary essential oil.

In the fifth of these, the cruciferous vegetable was kale, the seasoning was sea salt, the liquid was water, the edible fruit ingredient was banana puree, the acid ingredient was cider vinegar and the aromatic was cinnamon bark culinary essential oil and orange culinary essential oil.

In the sixth of these, the cruciferous vegetable was kale, the seasoning was sea salt, the liquid was water, the edible fruit ingredient was concentrated mango juice, the acid ingredient was cider vinegar and the aromatic was fresh kaffir limes leaves that were cooked with the kale.

What is claimed is:

1. A savory, healthy cruciferous vegetable formula, comprising the following ingredients:
a) cruciferous vegetable;
b) aromatic;
c) edible fruit ingredient;
d) acid ingredient;
e) seasoning;
wherein said ingredients are prepared, processed and packaged.

2. The formula of claim 1, wherein it is a pourable yet dense, finely textured, cruciferous vegetable condiment.

3. The formula of claim 1 wherein it is a carbonated, cruciferous vegetable beverage.

4. A method of preparing a pourable yet dense, finely textured, cruciferous vegetable condiment comprising the steps of:
a) preparing cruciferous vegetable;
b) combining cruciferous vegetable, aromatic, edible fruit ingredient, acid ingredient and seasoning;
c) cooking cruciferous vegetable, aromatic edible fruit ingredient, acid ingredient and seasoning:
d) pureeing cooked ingredients:
e) hot fill processing;
f) packaging;
wherein the pH of the resulting condiment is less than 4.5 and shelf-stable.

5. A method of preparing a carbonated, cruciferous vegetable beverage comprising the steps of:
a) preparing cruciferous vegetable;
b) combining cruciferous vegetable and seasoning;
c) cooking cruciferous vegetable and seasoning to a temperature and hold time lethal to bacteria:
d) transferring the cruciferous vegetable matter into a refrigerated storage container;
e) adding fruit ingredient and acid ingredient to the chilled cruciferous vegetable matter then agitating to mix ingredients:
f) carbonating then bottling the chilled aseptic fruit ingredient, acid ingredient and cruciferous vegetable matter;
wherein the pH of the resulting beverage is less than 4.5 and shelf-stable.

6. The carbonated, cruciferous vegetable beverage of claim 5 wherein said edible fruit ingredient is aseptic fruit juice.

7. The carbonated, cruciferous vegetable beverage of claim 5 wherein said edible fruit ingredient is aseptic fruit puree.

8. The carbonated, cruciferous vegetable beverage of claim 5 wherein said edible fruit ingredient is aseptic fruit concentrate.

9. The carbonated, cruciferous vegetable beverage of claim 5 wherein said aromatic is added to the cruciferous vegetable and cooked to extract flavor.

10. The carbonated, cruciferous vegetable beverage of claim 5 wherein said aromatic is added to the cruciferous vegetable broth once it has been chilled.

11. The carbonated, cruciferous vegetable beverage of claim 10 wherein said aromatic is a culinary-grade essential oil.
